(19) United States
(12) Patent Application Publication
(10) Pub. No.: US 2013/0068759 A1
(43) Pub. Date: Mar. 21, 2013

(54) Disposable dish covers

(71) Applicants: Victor Mirea, Dania Beach, FL (US); Alexandru Cristian Mirea, Hollywood, FL (US)

(72) Inventors: Victor Mirea, Dania Beach, FL (US); Alexandru Cristian Mirea, Hollywood, FL (US)

(21) Appl. No.: 13/200,122

(22) Filed: Sep. 19, 2011

(51) Int. Cl. H05B 6/80

(52) U.S. Cl. 219/734

(57) ABSTRACT

A disposable dish cover used to cover food in various forms of containers, dishes, bowls or plates, particularly when being used for cooking or heating in a microwave oven, to prevent bits of food or other fluids from being splashed throughout the interior of the microwave oven. The cover can also be used in numerous other ways such as to keep food warm, to keep flies away from food, prevent dust or debris from landing on food, prevent food smell spreading, etc.

### BACKGROUND OF THE INVENTION

The use and popularity of microwave ovens to prepare meals has required the development of containers, serving dishes, plates, and bowls for use within the microwave ovens, due to the unique qualities of the microwave ovens. These days, microwave ovens are used for cooking, reheating complete meals, reheating pre-packaged meals, and reheating of leftovers.

Heating process in a microwave oven has to be fast and clean. The food can be cooked in serving dishes, bowls, or plates from which the food is to be eaten. When the food is heated in a microwave oven, the container should be covered with a microwave safe material, to prevent splashing of food particles and fluids throughout the interior of the microwave oven. Splashing occurs when: 1.—water particles within a portion of heated food are rapidly converted to steam by the microwaves, or 2.—generation of hot spots, due to the lack of uniformity of microwaves penetration within the food being heated. These cause small areas of the food being heated to reach a rapid boiling point, and explode, splashing bits of food, or other fluids within the food, into the interior of the microwave oven, leaving the inside of the microwave oven dirty, and in need of cleaning. Also, sometimes it is necessary to boil the food, and in such instances, the interior of the microwave oven is likely to be soiled, by the splash of the boiling food.

Many materials are microwave resistant, including the paper. Often, people place a paper towel over the food being cooked or heated to protect the interior of the microwave oven against splashing. The use of the paper towel is inexpensive.

However, the paper towel often rests on the food, and undesirably absorbs the fluids from the food, causing the paper towel to stick to the food.

There is a need for a device for covering the food during the microwave oven cooking and heating, to protect the interior of the microwave oven from being splashed with food and fluids. Additionally, this device can serve for keeping the food warm, keeping the flies away from the food, keeping the dust or debris from landing on the food, and finally, preventing the food smell from spreading, while waiting to be served.

### SUMMARY OF THE INVENTION

The primary object of the invention is to provide a flexible cover for containers, serving dishes, plates, and bowls, used in a microwave oven.

Another object of the invention is to provide a flexible cover for containers, serving dishes, plates, and bowls, used in a microwave oven, as to block the splashed food and fluids, and prevent soiling of the interior of the microwave oven.

Still another object of the invention is to provide a cover for containers, serving dishes, plates, and bowls, used in a microwave oven as to keep the food warm, between the time of cooking or heating, and serving.

Still another object of the invention is to provide a cover for containers, serving dishes, plates, and bowls, used in a microwave oven as to keep the flies away from the food, between the time of cooking or heating, and serving.

Still another object of the invention is to provide a cover for containers, serving dishes, plates, and bowls, used in a microwave oven as to keep the dust and debris away from the food, between the time of cooking or heating, and serving.

Still another object of the invention is to provide a cover for containers, serving dishes, plates, and bowls, used in a microwave oven as to keep the flies away from the food, between the time of cooking or heating, and serving.

Still another object of the invention is to provide a cover for containers, serving dishes, plates, and bowls, used in a microwave oven as to prevent the food smell from spreading.

Still another object of the invention is to provide a cover of unique construction, which is easy and efficient to use, with containers, serving dishes, plates, and bowls of food being cooked or heated in a microwave oven.

Still another object of the invention is to provide a cover for containers, serving dishes, plates, and bowls, used in a microwave oven which is simple, inexpensive, and easy to use.

Still another object of the invention is to provide a cover for containers, serving dishes, plates, and bowls, used in a microwave oven which is of light weight, absorbent material, and sufficient inexpensive to be disposable after one use.

Still another object of the invention is to provide a cover for containers, serving dishes, plates, and bowls, used in a microwave oven which does not collapse during or after the cooking of heating of food in the microwave oven.

### BRIEF DESCRIPTION OF THE DRAWINGS

FIG. 1 is a perspective view of a dish cover according to our invention as it is the unfolded paper of the dish cover, with all the dimensions, and without the elastic cord.

FIG. 2 is a perspective view of a dish cover according to our invention as it is folded and ready to be used.

FIG. 3 is a perspective view of a dish cover according to our invention as it is placed on a dish with food, ready to be cooked or heated is a microwave oven.

### FIELD OF THE INVENTION

The invention relates to dish covers.
1. More particularly, the invention relates to dish covers for food dishes during heating within a microwave oven. Still more particularly, the invention relates to disposable dish covers for use during heating of food within a microwave oven.
2. More particularly, the invention relates to keeping food warm, after heating. Still more particularly, the invention relates to disposable dish covers for use of keeping food warm.
3. More particularly, the invention relates to dish covers for food, to keep flies away from food. Still more particularly, the invention relates to disposable dish covers for use of keeping flies away from food.
4. More particularly, the invention relates to dish covers for food, to prevent dust or debris from landing on the food. Still more particularly, the invention relates to disposable dish covers for use of preventing dust or debris from landing on the food.
5. More particularly, the invention relates to dish covers for food, to prevent smell spreading. Still more particularly, the invention relates to disposable dish covers for use of preventing smell spreading.

### DETAILED DESCRIPTION OF THE INVENTION

We have design a dish cover, of suitably adaptable size, which is intended to be placed over a food container, serving dish, plate, or bowl, being heated in a microwave oven, for one time use, and then discarded.

We have seen the necessity for such a cover to be efficient, adaptable to size of food container, inexpensive, resistant of bits of food and other fluids, yet permitting built-up steam to escape from the container. We have also considered most helpful for the dish cover to remain positioned above and out of contact with the food located in the container, even should the absorbent cover become saturated with bits of food and other fluids emanating from the cooked or heated food.

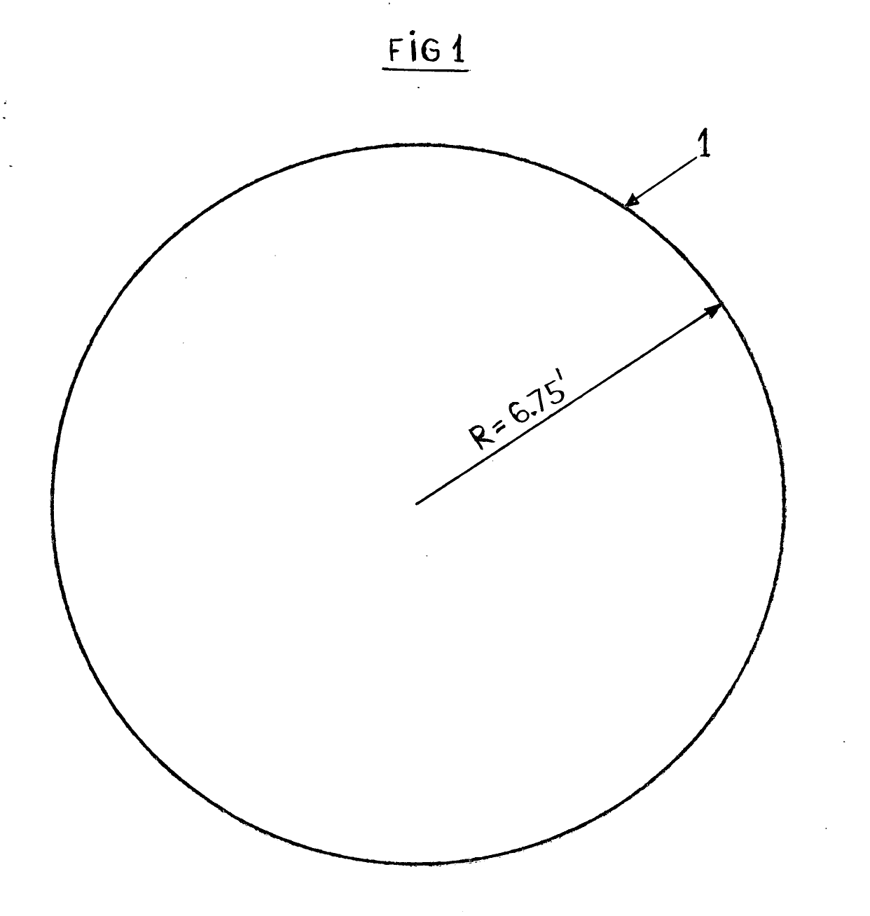

Referring to FIG. 1, it is the unfolded paper of the dish cover, with all the dimensions, and without the elastic cord.

The disposable microwave oven dish cover is made of a circular piece of tissue paper, with a radius ranging from 5.75″ to 7.75″, with the most preferred to be 6.75″, depending on the size of the container, dish, plate, or bowl it covers.

Currently, we are describing the 6.75″ radius size (1), with other sizes varying with an according scale. 0.70″ inside the edge of the circular piece of paper, there is a 6.05″ radius circle of thirty eight ⅛″ circular holes (2). The distance between the ⅛″ circular holes (3) is 1″ (4).

We have provided the dish cover with a 1/16″ vent hole (5), located in the center of the 6.75″ radius circular paper.

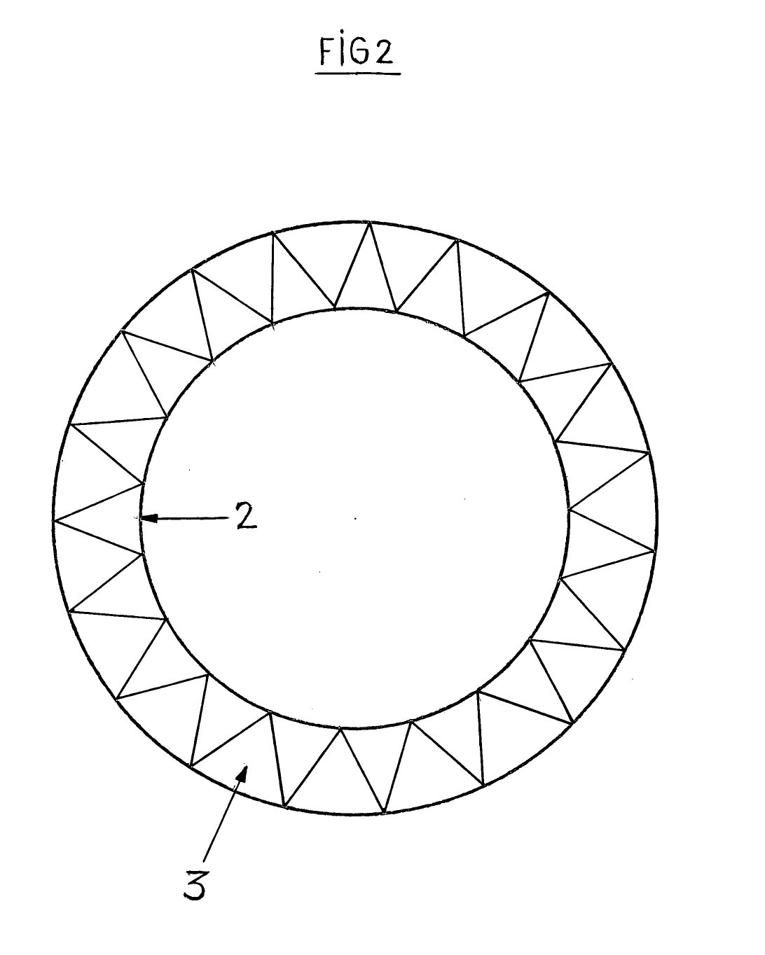

Referring to FIG. 2, it is the folded microwave oven dish cover, ready to be used. A 0.5 mm elastic cord (6), alternatively passes through the thirty eight ⅛″ circular holes, and folds the 6.75″ radius circular paper (7). The length of the elastic cord is 24″.

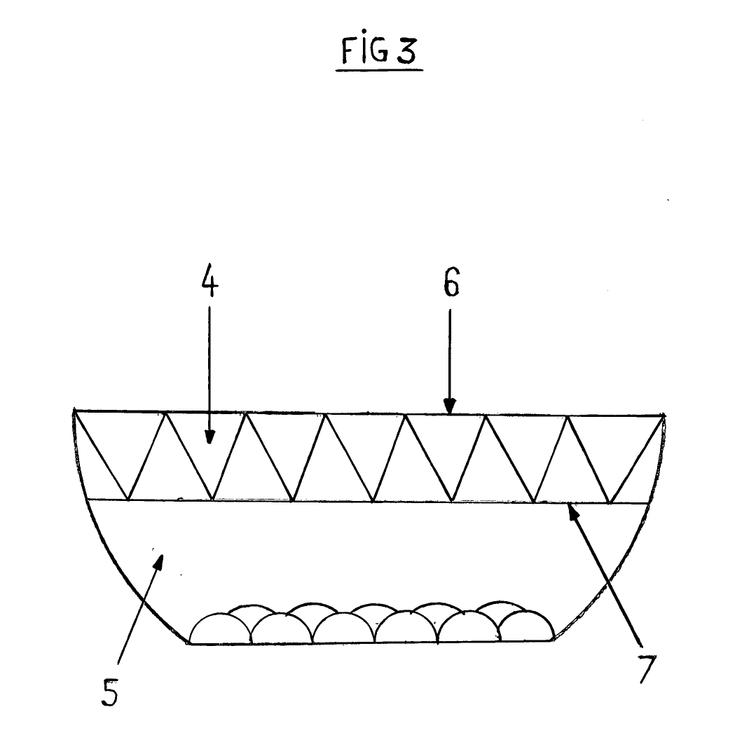

Referring to FIG. 3, it is the microwave oven dish cover (8) is placed on a dish with food (9), ready to be cooked or heated in a microwave oven. The top of the dish cover is flat on the edge of the dish. The elastic cord tightens the dish cover on the dish body.

The cover will be placed on the dish by stretching the elastic cord, sliding the cover over the dish, and releasing the elastic cord which will tighten the cover around the upper part of the dish. The food from the dish will be covered during the microwave oven cooking or heating, and the cover will protect the interior of the microwave oven from being splashed with food and fluids. The vent hole permits the easy and convenient escape of steam and other gaseous components generated during the cooking of heating process.

The dish cover remains positioned flat on top of the dish, above and out of contact with the food located in the dish, even should the cover become saturated with bits of food and other fluids emanating from the cooked or heated food.

Additionally, the dish cover can serve for keeping the food warm in a dish, keeping flies away from the food in the dish, keeping dust or debris from landing on the food in the dish, and finally, preventing food smell from spreading while the food is waiting to be served.

The folded dish covers may easily be stacked for packing, thus contributing to the convenience of handling of the dish covers and enabling the covers to be produced and sold more economically.

We claim as our invention in which an exclusive property and privilege is claimed, is defined as follows:

1. A disposable microwave oven dish cover, made out of paper, unitary substantially circular, flexible and absorbent.

2. A disposable microwave oven dish cover of claim 1 wherein the cover is made of tissue paper.

3. A disposable microwave oven dish cover of claim 1 with circular holes located inside the edge of the dish cover of claim 1, disbursed along the circumference of said paper.

4. A disposable microwave oven dish cover of claim 1 wherein a vent hole is located in the center of the circular paper.

5. A disposable microwave oven dish cover of claim 1 wherein an elastic cord alternatively passes through a number of circular holes along the circumference of outer edge of the paper, constricting the circular paper to the rest position of the elastic band which is less in length than the circumference of the circular paper.
